(19) United States
(12) Patent Application Publication
(10) Pub. No.: US 2017/0081009 A1
(43) Pub. Date: Mar. 23, 2017

(54) METHOD AND ARRANGEMENT FOR CONTINUOUS ALIGNMENT OF A ROTATING SHAFT

(71) Applicants: PROPULSION SOFTWARE AB, Hammaro (SE); DE FIN - OFFSHORE & HYDRAULICS, Rozenburg (NL)

(72) Inventors: Anders RUBIN, Hammaro (SE); Willy RANTANEN, Rozenburg (NL)

(73) Assignee: PROPULSION SOFTWARE AB, Hammaro (SE)

(21) Appl. No.: 15/312,061

(22) PCT Filed: May 19, 2015
(86) PCT No.: PCT/SE2015/050563

§ 371 Date: Nov. 17, 2016

(30) Foreign Application Priority Data
May 19, 2014 (SE) 1450581-2

(51) Int. Cl. B63H 23/32; F16C 23/08; F16C 41/02; F16C 23/04

(52) U.S. Cl. CPC B63H 23/321; F16C 23/04; F16C 23/08; F16C 41/02; B63H 2023/322; F16C 2233/00; F16C 2326/30

(57) ABSTRACT

This invention relates to a method and an arrangement for continuous alignment of a propeller shaft, including at least one adjustment unit with an actuator arranged to be fitted between a bearing housing and a support beam, and to enable adjustment of the position of an adjustable bearing in relation to the support beam, wherein the actuator includes an actuating member with threads interfitting with threads on at least one adjustment member, wherein an activating member is arranged to rotate the actuating member to achieve adjustment, and wherein at least a first and a second adjustment unit arranged to be connected to said bearing housing having their adjustment members orthogonally movable in relation to each other.

### TECHNICAL FIELD

This invention relates to a method and an arrangement for continuous alignment of a rotating shaft, comprising at least one adjustment unit with an actuator arranged to be fitted between a bearing housing and a support beam, and to enable adjustment of the position of the bearing in relation to the support beam.

### BACKGROUND

This invention may be used in many different applications, but in the following it will be referred to ships, i.e. without any limiting effect. Ships are very costly and therefore need to be heavily operated to be profitable. Accordingly, damages that may lead to stand still are highly undesired. A large amount of standstill of ships related to propulsion damages. It is recognized and well known that almost all propulsion damages are directly or indirectly related to misalignment.

Systematic follow-up facilities for misalignment are rarely used during ship operation. Much of the difficulties experienced with ship's propulsion machinery can be attributed to shaft alignment problems brought about by hull deflections and inappropriate analyses and practices. Required shaft alignment accuracy (˜0.1 mm) and bearing clearance/˜1 mm) cannot always cope with hull deflections, which may be several centimeters. Many propeller shaft bearings are regularly operating under misaligned conditions resulting in gradual bearing fatigue or catastrophic bearing failures

Today the alignment of propeller shafts in ships is normally done at the shipyard. After the ship's launching, the alignment is left to its own fate without any control or correction facilities. No preventive measures are taken before bearing failures or the next bearing overhaul in dock.

Discussions on the analytical problems have been on-going for decades. Still, the same mathematical models remain in use, It has been obvious that the general and uncritical use of the single support point bearing model is one of the main reasons for the poor analyses. This simplified model is inappropriate for analysis of operation conditions. Only concentrated static bearing loads can be considered.

It is not possible to analyze how the lubrication oil film acts on the pressure distribution in operation condition. The dilemma is traditionally evaded by assuming even distribution. The concentrated bearing, load is simply divided by the supporting area to obtain the pressure.

Another deficiency of the simplified model is its inability to reveal any possible load peaks in the bearing edges in operation condition. Such load peaks are quite common. They are often counter-directed, which means that an unloaded zone occurs in between. Unloaded zones may cause problems, since they are typical vibration sources.

Nevertheless, using traditional and obsolete shaft alignment methods is a well-established practice in the shipbuilding industry, including class societies.

In SE 500490 there is suggested a method for improved handling of shaft misalignment, by means of movable bearing supports controlled by a computer system. However, the method presents some disadvantages and has therefore not reached any market success,

Further U.S. Pat. No. 5,906,523 discloses an arrangement for handling of shaft misalignment, which present disadvantages, e.g. in the use of relatively imprecise hydraulic actuators.

### BRIEF SUMMARY OF THE INVENTION

The main purpose of the invention is to provide improved operation of machinery, in order to minimize/avoid misalignment and mechanical behavior causing inappropriate bearing loads and/or wear/vibrations, as defined in claim 1. Thanks to the invention less failure and/or vibrations will he caused, and/or less maintenance will be needed, to parts and machinery connected to a shaft.

The invention is especially suitable for marine propulsion. Alignment may be maintained irrespective of ship operation condition or hull deflections, etc., by means of correctly aligning the propeller shafting during ship operation. Thanks to the invention the propeller shaft bearings may be disengaged from the ship foundation and hull deflections, implying that propeller shaft bearings will fail less and need less maintenance throughout the lifetime of the ship.

Further, thanks to the invention the regular bearing overhaul in dock required by class rules may become superfluous, The Time Between Overhaul (TBO) of ships in dock are generally determined by propeller shaft surveys. Prolonged TBO by means of the invention may save loss of hire and other costs arising from bearing overhaul in dock.

Thanks to a preferred arrangement continuous and automatic adjustment of the bearings may be performed during ship operation, which may replace a big part of the traditional one-off procedure of manual shaft alignment at the ship yard.

For the ship owner, the most important economic advantage of using the invention is saving all the costs brought about by misalignment, not least the loss of hire due to class-required regular stops for tail shaft survey in dock.

Delays may be avoided during the new build phase due to a more simplified shaft alignment procedure, e.g. the jack and gap-sag methods are not required.

In relation to Shipbuilding the following advantages may be obtained.
Reduced manufacturing costs, and/or
Simplified alignment analysis and installation practices of propeller shafts, and/or
The jack and gap-sag methods may be dispensed with, and/or
The propeller shafting can be installed before the superstructure is mounted on the hull, and/or
Shorter shipbuilding time in dock.

### BRIEF DESCRIPTION OF DRAWINGS

In the following the invention will be described in more detail with reference to the enclosed figures, wherein

FIG. 1 schematically shows a ship's propulsion machinery,

FIG. 2 shows a graph presenting distributed bearing pressure and shaft line deflection for an exemplary propeller shaft of a ship, and

FIG. 3 shows a presentation of the multi support point hearing model used in the software for automatic alignment in accordance with a further aspect of the invention, and,

FIG. 4 shows a cross-sectional view of an arrangement for alignment in accordance with the invention.

### DETAILED DESCRIPTION

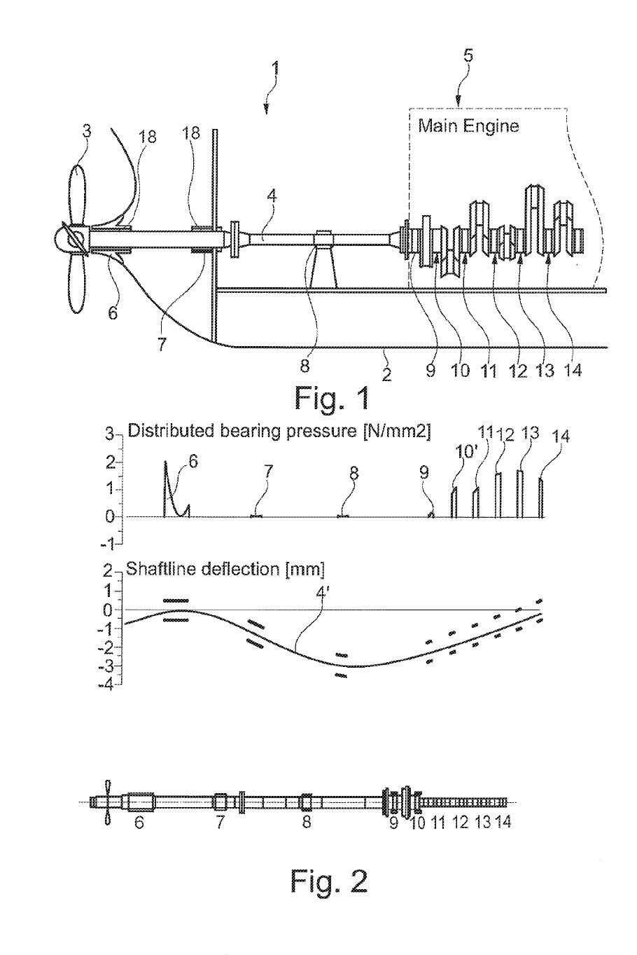

In FIG. 1 there is shown a schematic side view of the aft part of a ship 1 having a hull 2, a propeller 3, a propeller shaft 4 and a main engine 5. In a traditional manner the propeller shaft 4 is supported by a number of bearings 6-14 that can vary as is well known by the skilled person. Further it is indicated that the bearings 6-14 are equipped with pressure measuring devices 18.

In FIG. 2 there are shown graphs presenting typical values for a propeller shaft 4 in operation condition, in accordance with a preferred aspect of the invention including computerized control of the positioning of the shaft bearings. In the upper graph the distributed bearing pressure for the plurality of bearings 6-14 are shown, wherein in this example it is related to journal bearings, e.g. oil-lubricated bearings, but as is evident for the skilled person the advantages of the principles according to the invention also apply in relation to other kind of bearings, e.g. roller and/or bail bearings and/or water lubricated journal bearings.

In each bearing the positioning is chosen such that an offset is obtained that matches an optimal shaft line 4′ that preferably will apply an upwardly directed pressure on the shaft 4 in most, preferably all over the supporting area of the bearings, by the use of adjustable units 16. 16′ for one or more bearing housings, e.g. 7 and 8. As a consequence the resulting pressure preferably will positively support (i.e. upwardly directed) the shaft 4 in operation condition, and by using adjustment units 16, 16′ in accordance with the invention, for one or more chosen bearings (preferably both, or at least one intermediate bearing's 7, 8) most, or preferably all, beatings will be aligned such that the shaft line 4′ will cause a satisfactory oil film thickness and an even distributed pressure. Hence, in the preferred mode no misalignment nor any unloaded zones occur in any operation condition, which may guarantee optimized life time of the bearings and the absence of vibration sources. In the graph below there is shown a typical shaft line deflection 4′ for a shaft supported by a plurality of oil-lubricated bearings 6-14. As shown, the bearing tilts are preferably all together calculated to give an upwardly directed supporting pressure in all bearings 6-14.

As can be noted in the upper graph in FIG. 2 the aft bearing 6 (the aft bearing 6 of the sterntube bearings 6, 7) is especially loaded in comparison with other bearings. As already mentioned above this aft bearing 6 more often is damaged than other bearings and as a consequence the invention is especially suited for use to control the load of the sterntube bearings 6, 7. However, as is evident for the skilled person the invention may be applied to any or all of the intermediate shaft bearings or a chosen number of bearings in accordance with different needs and requirements. In accordance with a preferred embodiment of the invention the aft and forward sterntube bearings 6 and 7 and the engine bearings 9-14 are not equipped with adjustment units 16, 16′, but merely the intermediate bearing 8, that preferably is an easily accessible bearing arrangement. Hence, in accordance with a preferred embodiment an intermediate bearing is equipped with adjustment units 16, 16′ to align the shaft 4 optimally to arrange for optimal alignment (offsets) and for applying an upwardly directed supporting pressure on the shaft 4 and thereby maintain a desired alignment of the shaft 4, for every bearing (or possibly an optimal alignment for at least one or a selected set of bearings), such that damaging forces applied to the bearings are eliminated or at least minimized.

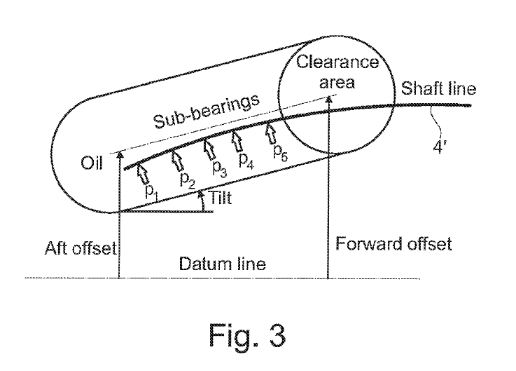

In FIG. 3 is schematically shown the principles of a multi support point bearing model that may be used in accordance with the invention to optimize the adaption between the bearing offset/tilt and the shaft line, (in the figure there is also shown a reference line of the stern tube (Datum line)) to arrange for optimal offset/tilt of each bearing for achieving optimal pressures (p1-p5) within each sub-bearing. An objective is to obtain a satisfactory oil film thickness and an even distributed pressure.

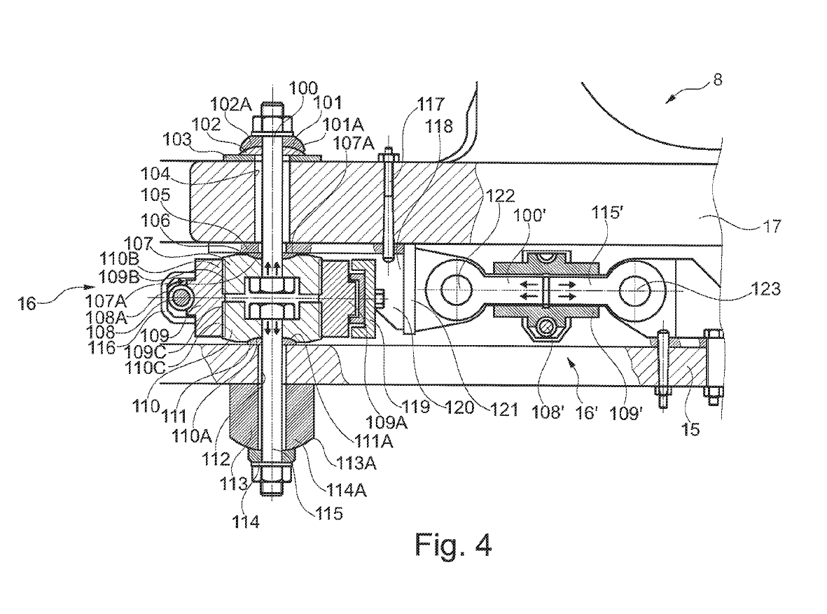

In FIG. 4 there is presented a cross-sectional schematic view of an arrangement in accordance with one embodiment according to the invention. There is shown a bearing house bottom 17, e.g. forming a part of bearing house of the above exemplified intermediate bearing 8. The bearing house bottom 17 is connected to a beam 15 fixedly attached to the hull 2 of the ship 1. In between the bearing house bottom 17 and the beam 15 there are positioned a first 16 and a second 16′ adjustment unit.

In the following merely one of the adjustment units 16 will be described more in detail, because in principle the two units 16, 16′ have the same functionality.

The adjustment unit 16 comprises an upper screw element 100 that is fixedly attached to an upper, non-turning washer 107 at its lowermost end, via a central bore in the washer 107. The washer 107 is pressed against the lower surface of the bearing house 14. The upper end of the screw 100 presses a first contact body 101 against a first tiller body 102 and in turn against a ring member 103 that is in contact with the upper surface of the bearing house. The first tiller body 102 has an outer spherical surface 102A that matches a corresponding concave surface of the pressure element 101. Also between the upper washer 107 and the lower surface of the bearing house 14 there is arranged a similar mechanism, i.e. a second filler body 106 with a spherical surface 106A in contact with a corresponding concave surface 107A of the washer. The upper surface of the second tiller body 106 is substantially flat and presses against a flat portion 105 of a bracket 120, having substantially same thickness as the ring member 103. The upper washer 107 is at its peripheral cylindrical surface arranged with fine metric left thread 100A, mating with a surrounding nut 109 having corresponding threads 109B. The height of this nut 109 is substantially larger than the height of the upper washer 107.

Within the lower half of the nut 109 there is interfitted a lower washer 110 arranged with fine metric right thread 110C. These threads 110C match with corresponding threads 109C within the lower half of the nut 109. At the outer periphery of the nut there is arranged a horizontally extending trapeze thread 109A, i.e. arranged annularly.

Interfitting with the trapeze thread 109A there is a worm gear spindle 108 having corresponding threads 108A. Outside of the worm gear spindle 108 there is arranged a spindle housing 116. The tower washer 110 is fixed to the beam 15 in a corresponding manner as the upper washer 107 is attached to the bearing house 14. Accordingly the lower washer 110 has a lower most concave surface 110A that matches the outer spherical surface 111A of a third filler 111. Also at the lowermost end of the lower screw element 115 there is arranged a kind of pressure element 114 having a concave surface 114A matching the convex surface 113A of distance element 113 in contact with the lowermost surface of the beam 15.

Moreover, it is to be noted that the diameter D of the holes 104, 112 for the screws 100, 115 are substantially larger than the outer diameter d of the screw body providing a gap wherein the screw bodies 100, 115 may be displaced. Preferably D is within the range of 1,1-2×d, more preferred 1,2-1,8×d.

When rotating the worm spindle 108 the nut 109 will be rotated which in turn will arrange for movement of the upper and lower washers 107, 110, that will displace the screw elements 100, 115. In this manner the vertical distance between the hearing house 14 and the beam 15 may be adjusted, and thereby the vertical position of the bearing 6.

Preferably the gear ratio is between 50:1-200:1, more preferred 100:1 implying that 100 turns of the worm spindle will result in one turn of the nut 109. Preferably the threads of the nut 9 is in the range of M20 to M30 and the height of the nut is in the range of 50 to 200 mm, more preferred 100 to 150 mm.

In a similar manner the rotation of the worm gear spindle 108′ of the second unit 16′ will arrange for displacement, such that the distance between the stub shafts 122,123 may be adjusted, by means of their connection to each one of the moveable screw elements 100′, 115′. One of the stub shafts 122 is fixedly attached to the bearing housing 14, by means of a first bracket 120. The other stub shaft 123 is fixedly attached to the beam 15, by means of the second bracket 124.

When the second unit 16′ is activated displacement of the bearing housing 14 in relation to the beam 15 will occur by a substantial parallel movement them between. Hence it will cause the bearing housing 14 to change its horizontal position in relation to the beam 15, thereby enabling an adjustable off set of the bearing 6 in a horizontal plane, which is feasible thanks to arrangement of relatively large gaps between the through holes 104, 112 and the screw elements 100, 115. Further, thanks to the preferred arrangement of spherical elements 102, 106, 111, 113; 122, 123 the angular repositioning of the first adjustment unit 16, may be achieved without introduction of any substantial bending stress. The radius R for the surfaces 111A, 113A, is chosen such that the screw body 100 115 may deflect and maintain substantially the same pressure.

Preferably the radius R will be within the range of 0,3-0,7×L, where L is the length of the screw body 100, 115.

An ingenious aspect of invention is the ability to keep the bearing house 14 in solid contact with the foundation structure 15 during adjustments. A controlling software may preferably be included.

The device may operate under each corner of a standard shaft bearing 6 by performing adjustments of the bearing bolts 100, 115; 100′, 115′ automatically and carefully to achieve favorable bearing pressures and lubrication oil films without risking the strength.

Bearing offsets and tilts may be adjusted in the vertical and the horizontal planes. A preferred objective is to maintain an optimized adaption between the bearing position and the shaft line 4′ in any operation condition. Only mechanical and hydraulic standard components may in the preferred embodiment be used, without jacks. The device is very easy to maintenance.

The invention may substantially eliminate all misalignment during ship operation. A satisfactory alignment in all operation conditions may therefore in future become something to take for granted. The installation can be done on new builds as well as on existing vessels in service when the vessel is in dock for tail shaft survey.

SoftAlign, is the trade name tor an existing shaft alignment software that is well suited to be used in the invention. Older versions have been used in the international shipbuilding industry. According to a preferred mode of the invention a new ‘multi support point beating model’ may be used to enable improved alignment, e.g. including consideration of a plurality of bearings supporting a shaft and preferably also of bearing length, clearance and oil film thickness, as indicated in FIG. 3. It is also possible to consider different aft and forward offsets (tilted bearings). This facility may be useful to avoid counter-directed loads in the bearing edges.

The known software system, “SoftAlign”, may be used to control the new arrangement continuously and automatically during ship operation. By means of input and output signals, an optimization procedure may be used to control and correct the oil film pressure in the support points as the operation conditions change. Preferably the bearing pressure is kept as even as possible all the time, which may exclude wear and vibration. In such a system Input signals/data measured by sensors, may provide real time data e.g. pressure in the bearing bolts, which are used by the software to supply Output data that may control the arrangement to carefully adjust the aft and forward offsets (tilt) of each beaming in both the vertical and horizontal planes.

Accordingly the invention provides many advantages, e.g.:
Adapts bearing offsets and tilts to the shaft line in the present operation condition.
Performs careful adjustments of the bolts in each bearing corner without risking the strength.
Uses only mechanical and hydraulical standard components without jacks.
Easy to maintenance.

The invention is not limited by the embodiment described above. As the skilled person can foresee there exist other options to achieve the basic advantages in accordance with the invention. For example instead of a spindle drive it is possible to use other known mechanisms that provide the same kind of functionality. Further it is evident for skilled that a variety of sensors may be used to give desired input signals/data regarding bearing and shaft conditions, e.g. shaft deflection sensors, strain gauges inductive sensors in the bearing edges, etc.

1. A device for continuous alignment of a shaft, comprising: at least one adjustment unit with an actuator arranged to be fitted between a bearing housing and a support beam, and to enable adjustment of the position of an adjustable bearing in relation to the support beam, wherein said actuator includes an actuating member with threads interfitting with threads on at least one adjustment member, wherein an activating member is arranged to rotate said actuating member to achieve adjustment, and wherein the at least one adjustment unit comprises at least a first and a second adjustment unit that are arranged to be connected to said bearing housing having their adjustment members orthogonally movable in relation to each other.

2. A device according to claim 1, wherein said actuating member includes a nut with a pair of interior facing threads interfitting with exterior threads of a first and second adjustment member, respectively, wherein said threads include one right thread and one left thread, respectively.

3. A device according to claim 1, wherein angular repositioning of said adjustment unit is enabled without introduction of any substantial bending stress.

4. A device according to claim 3, wherein said at least one adjustment unit has a first attachment part arranged to be fixedly connected to the bearing housing and a second attachment part arranged to be fixedly connected to the support beam.

5. A device according to claim 1, wherein said device is mounted on ship and said shaft is a propeller shaft.

6. A method for operating the device of claim 1, comprising: registering and storing data during operation from a plurality of first bearings supporting said shaft; measuring at least one parameter indicating the state of stresses in the shaft; and calculating by means of a computer running a specific software how the bearings should be repositioned in view of the measured parameter and the prescribed conditions.

7. A method as claimed in claim 6, wherein the step of measuring comprises measuring pressures exerted on at least one second bearing other than the adjustable bearing.

8. An arrangement for continuous alignment of a shaft, comprising at least first and second adjustment units with actuators arranged to be fitted between a bearing housing and a support beam, enabling adjustment of a position of an adjustable bearing in relation to the support beam, wherein said first and second adjustment units are arranged to be connected to said bearing housing having their adjustment members orthogonally movable in relation to each other.

9. An arrangement as claimed in claim 8, wherein angular repositioning of a first adjustment unit is enabled without introduction of any substantial bending stress.

10. An arrangement according to claim 8, wherein said second adjustment unit has a first attachment part arranged to be fixedly connected to the bearing housing and a second attachment part arranged to be fixedly connected to the support beam.

11. An arrangement according to claim 8, wherein a pressure measuring device is arranged to at least one second bearing other than the adjustable bearing.

12. An arrangement according to claim 11, wherein a plurality of second bearings are arranged with pressure measuring devices.

13. An arrangement according to claim 12, wherein said plurality of second bearings includes at least one second bearing positioned on a first side in relation to said adjustable bearing and at least one second bearing positioned on a second side in relation to said adjustable bearing.

14. The method of claim 7, wherein the at least one second bearing comprises a plurality of second bearings.

15. The method of claim 7, wherein the plurality of first bearings comprises at least one bearing positioned on a first side in relation to said adjustable bearing and at least one bearing positioned on a second side in relation to said adjustable bearing.
